(19) United States
(12) Patent Application Publication
(10) Pub. No.: US 2006/0045022 A1
(43) Pub. Date: Mar. 2, 2006

(54) Apparatus, and associated method, for generating packet acknowledgment replies during operation of a packet communication system

(76) Inventors: Jarkko Kneckt, Espoo (FI); Mika Kasslin, Espoo (FI); Jari Jokela, Ylojarvi (FI)

Correspondence Address: Robert H. Kelly;Scheef & Stone, L.L.P., Suite 1400, 5956 Sherry Lane, Dallas, TX, 75225, US

(21) Appl. No.: 10/931,269

(22) Filed: Aug. 31, 2004

(51) Int. Cl. H04Q 7/24; H04L 12/26

(52) U.S. Cl. 370/252; 370/338; 370/428

(57) ABSTRACT

Apparatus, and an associated method, for facilitating communication of a packet acknowledgment in a packet communication system. Detectors detect the data rate at which data packets are communicated to a receiving station and whether the data packets are successfully delivered to the receiving station. A packet acknowledgment frame generator generates a packet acknowledgment frame that is of values responsive to the detection made by the detectors and is transmitted at a transmission rate responsive to the detected data rate.

The present invention relates generally to communications in a packet communication system, such as a WLAN (Wireless Local Area Network) that operates pursuant to the operating protocols of a variant of an IEEE 802.11 operating specification. More particularly, the present invention relates to apparatus, and an associated method, by which to facilitate communication of packet acknowledgment replies generated at a communication station pursuant to a selected packet acknowledgment scheme. The packet acknowledgment replies acknowledge whether data packets delivered to the communication station are delivered successfully.

The transmission rate at which packet acknowledgment replies are communicated is selectable, and the rate is responsive to the data rate at which data packets are sent to the communication station. Improved communication throughput rates are achieved. In contrast to conventional packet-acknowledgment schemes that require the packet acknowledgment replies to be transmitted at a lowest possible transmission rate, packet acknowledgment replies are sent, e.g., at highest-possible rates, thereby to minimize communication delays.

### BACKGROUND OF THE INVENTION

Ready access to communication systems through which to communicate is a practical necessity of modern society. During operation of a communication system, data is communicated between a set of communication stations in which at least one of the communication stations forms a sending station and at least another of the communication stations forms a receiving station. The sending and receiving stations are interconnected by way of a communication channel.

During a communication session by which to effectuate a communication service, data is communicated by the sending station upon the communication channel for delivery to the receiving station. The receiving station detects delivery of the data thereto, and the receiving station operates to recover the informational content of the communicated data.

Communication systems of differing constructions and capabilities provide for the effectuation of various types of communication services. New types of communication systems that permit the effectuation of new types of communication services have been developed and deployed, permitted as a result of advancements in communication technologies.

A radio communication system is an exemplary type of communication system. The communication channel used to interconnect sending and receiving stations of the radio communication system is formed of a radio channel, defined upon a radio link, i.e., a non-wireline link, extending between the communication stations. Because communications are effectuated upon a channel defined upon a radio link rather than a channel defined upon a wireline, communication stations of a radio communication system need not be positioned at locations that are permitting of connections to wirelines. Communications are effectuable by way of a radio communication system by way of communication stations positioned at locations from which communications would not be permitted by way of wireline communication systems. Increased availability of communications is sometimes thereby provided through use of radio communication systems. Additionally, radio communication systems are implementable as mobile communication systems in which one or more of the communication stations is provided with communication mobility.

Amongst the advancements in communication technologies are advancements in digital communication techniques. Use of digital communication techniques provide various communication advantages, amongst which include more efficient data communications, permitting bandwidth allocations to a communication system to be more efficiently utilized.

When digitized, the data is formed of sequences of digital bits that are sometimes formatted into sequences, referred to as packets. Various protocols have been developed and popularly utilized by which to format the data into packets.

Wireless local area networks (WLANs), for instance, are radio communication systems that provide for the communication of data through the communication of packet-formatted data. Data packets are communicated between communication stations of a WLAN by way of radio channels defined in the WLAN system. Operating protocols set forth in a variant of an IEEE (Institute of Electrical and Electronic Engineers) are regularly utilized in a WLAN system. The IEEE 802.11 (b), (a), (g), and (n), for instance, all set forth operating protocols by which to communicate packet-formatted data pursuant to effectuation of communication services.

The operating protocols set forth in these variants of IEEE 802.11 specification define packet acknowledgment procedures by which a receiving communication station that is to receive a data packet selectably acknowledges receipt of the packet. Positive acknowledgment, negative acknowledgment, block acknowledgment, and other acknowledgment schemes are variously set forth in various ones of the variant IEEE 802.11 operating protocols. Other packet-based communication schemes also sometimes provide for the packet acknowledgment procedures.

The variants of the IEEE 802.11 operating protocols provide for various communication data rates. At higher data transmission rates, the throughput of communications are higher than at lower data transmission rates. However, existing operating protocols require that the packet acknowledgments, of whatever type, be transmitted at a lowest permitted transmission rate. The existing requirement that the packet acknowledgments be transmitted at a lowest possible transmission rate adversely affects the total data throughput rates.

If a manner could be provided by which to permit the packet acknowledgments at least selectably to be transmitted at a transmission rate greater than the lowest possible transmission rate, improved communication performance of a packet communication system, such as the aforementioned WLAN system, would be achievable.

It is in light of this background information related to packet communications in a packet communication system that the significant improvements of the present invention have evolved.

### SUMMARY OF THE INVENTION

The present invention, accordingly, advantageously provides apparatus, and an associated method, by which to perform packet communications in a packet communication system, such as a wireless local area network (WLAN) that operates pursuant to the operating protocols of a variant of an IEEE 802.11 operating specification.

Through operation of an embodiment of the present invention, a manner is provided by which to facilitate communication of packet acknowledgment replies. The packet acknowledgment replies are generated at a communication station pursuant to a selected packet acknowledgment scheme. The packet acknowledgment replies acknowledge whether data packets delivered to the communication station are delivered successfully.

The transmission rate at which a packet acknowledgment reply is not fixed, but rather is selectable, responsive to the data rate at which data packets are transmitted.

Conventional packet-acknowledgment schemes require that packet-acknowledgment replies be transmitted at a lowest-possible transmission rate. By permitting packet acknowledgment replies to be sent at higher transmission rates, e.g., at highest-possible rates, communication delays are reduced and improved communication throughput rates are achievable.

In one aspect of the present invention, the packet communication system is a variable-rate communication system. That is to say, the more than one transmission rate is selectably available in the packet communication system. And, if the communication stations that are parties to a communication session are capable of operating at a relatively high data transmission rate, communications between the communication stations are effectuated at the relatively high data communication rates, thereby to facilitate communication of data pursuant to a communication service at correspondingly high communication rates. When the data communication rate at which data packets are communicated is selected and the data packets are communicated, packet-acknowledgment replies that are generated pursuant to a packet acknowledgment scheme are generated and transmitted at transmission rates that correspond to the data transmission rates at which the data packets are delivered. That is to say, a sending station sends data packets at the selected transmission rate for delivery to a receiving station. Once the data packets are delivered to the receiving station, a packet acknowledgment is generated pursuant to the packet acknowledgment scheme pursuant to which the packet communication system is operable. A detector detects the transmission rate at which the data packet is transmitted to the receiving station. The detector detects the transmission rate of the data packet or otherwise detects the transmission rate based upon the allocated transmission rate pursuant to which the transmission rate is to be effectuated. Responsive to the detection made by the detector, the transmission rate at which the packet-acknowledgment reply is transmitted is selected and used by which to transmit the packet acknowledgment back to the sending station.

The packet-acknowledgment scheme pursuant to which the packet acknowledgment replies are generated is of any of various schemes. For instance, the packet-acknowledgment replies are generated pursuant to a positive acknowledgment scheme, a negative acknowledgment scheme, a lock acknowledgment scheme, or other appropriate acknowledgment scheme.

An acknowledgment frame generator operates to generate an acknowledgment frame populated with a value or values that are appropriate according to the packet acknowledgment scheme that is utilized and determination of whether the data packet has been successfully delivered to the receiving station. Once generated, the acknowledgment frame is communicated to the sending station at a transmission rate selected responsive to the detections made by the detector. As the transmission rate at which the acknowledgment frame is communicated back to the sending station is selectably of a rate greater than the minimum transmission rate available in the communication system, improved communication efficiencies are possible.

In one implementation, the packet communication system is operable pursuant to an IEEE 802.11(b) operating specification. When the communication system is operable pursuant to this variant of the IEEE 802.11 operating specification, the transmission rate at which the packet acknowledgment replies are returned to the sending station correspond to the transmission rate at which the data packets are delivered to the receiving station.

In another implementation, the packet communication system is operable pursuant to an IEEE 802.11(a) operating specification. When the communication system is operable to this variant of the IEEE 802.11 operating protocols, the data transmission rate at which the packet-acknowledgments are returned to the sending station correspond to the transmission rates at which the data packets are delivered to the receiving station up to a maximum level. When the data rate at which the data packets are delivered to the receiving station exceed the maximum level, the packet acknowledgment replies are returned to the sending station at a transmission rate that corresponds to the transmission rate associated with the maximum level. More generally, the maximum level is determined by the time duration of the symbols used in, and defined by, the operating specification. The transmission rate does not exceed the transmission rate associated with the transmission of symbols of the defined symbol durations.

In another implementation, the packet communication system is operable pursuant to the IEEE 802.11 (e) operating specification. When the communication system is operable pursuant to this variant of the IEEE 802.11 operating specification, at least selected data packets that are formed and communicated pursuant to operation of the communication system include a QoS (Quality of Service) control field. And, the QoS control field contains an acknowledgment policy field that, pursuant to an embodiment of the present invention, is formed of a field length of three bits. When the acknowledgment policy field is of the three-bit, bit length, the field can take any of a dight possible values. Through appropriate selection of the values that populate the field, the packet acknowledgment scheme is identified selectably to be of any of an increased number of packet acknowledgment types.

Improved communication efficiency results as the packet acknowledgment scheme and acknowledgment frames generated pursuant to the packet acknowledgment schemes are returned to the sending station at, selectably, rates greater than minimum system rates.

In these and other aspects, therefore, apparatus, and an associated method, is provided for a packet communication system. The packet system has a set of communication stations that are formed of a first communication station and at least a second communication station. The first communication station is at least for sending packet-formatted data to the second communication station pursuant to a selected feedback acknowledgment scheme. Feedback acknowledgment by the second communication station pursuant to the selected acknowledgment feedback scheme is facilitated. A packet detector is adapted to receive indications of delivery of a data packet of the packet-formatted data at the second communication station. The packet detector generates an acknowledgment value responsive to whether the data packet is successfully delivered to the second communication station. A rate detector is adapted to receive indications of the delivery of the data packet of the packet-formatted data to the second communication station. The rate detector detects at what data rate that the data packet is communicated by the first communication station to the second communication station. An acknowledgment frame generator is adapted to receive indications of the acknowledgment value and to receive indications of the data rate. The acknowledgment frame generator generates an acknowledgment frame populated with an acknowledgment field value responsive to the acknowledgement value. The acknowledgment frame is for transmission back to the first communication station at a transmission rate responsive to the data rate.

A more complete appreciation of the present invention and the scope thereof can be obtained from the accompanying drawings that are briefly summarized below, the following detailed description of the presently-preferred embodiments of the present invention, and the appended claims.

### BRIEF DESCRIPTION OF THE DRAWINGS

FIG. 1 illustrates a functional block diagram of a packet communication system in which an embodiment of the present invention is operable.

FIG. 2 illustrates a diagram representative of exemplary data packets communicated pursuant to operation of the packet communication system shown in FIG. 1.

FIG. 3 illustrates a table identifying a QoS control field including an acknowledgment policy field used pursuant to an embodiment of the present invention during operation of the packet communication system shown in FIG. 1.

FIG. 4 illustrates a table identifying values populating the acknowledgment policy field of the QoS control field shown in FIG. 3.

FIG. 5 illustrates a method flow diagram listing the method of operation of an embodiment of the present invention.

### DETAILED DESCRIPTION

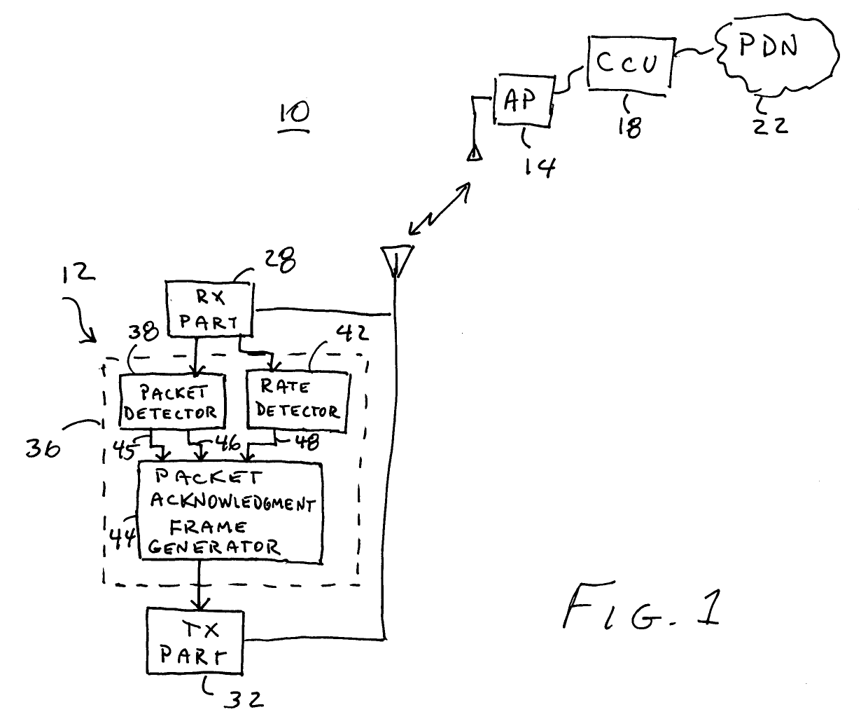

Referring first to FIG. 1, a packet communication system 10, here a WLAN (Wireless Local Area Network), forms a radio communication system through which communications are effectuated by the communication of packet-formatted data. Packet communications are effectuated between a network part of the WLAN and mobile stations, of which the mobile station 12 is representative.

In the exemplary implementation, the WLAN, of which the packet communication system is formed, is operable pursuant to a variant of the IEEE 802.11 operating specification. In its various implementations, the communication system is operable in general conformity with any of the IEEE 802.11(b), (a), (g), and (n) operating specifications. While the following description of the exemplary implementation of the present invention shall be described with respect to its implementation as an IEEE 802.11-compliant communication system, operable generally pursuant to the operating protocols of an appropriate variant of the IEEE 802.11 operating specification, the communication system 10 is analogously also representative of other types of packet, and packet radio, communication systems. Description of operation of an embodiment of the present invention with respect to its implementation in such another packet communication system is analogous to that described herein with respect to the exemplary implementation.

The network part of the WLAN includes a plurality of spaced-apart access points (APs), of which the access point 14 is representative. The access points are positioned at spaced-apart locations throughout an area that is to be encompassed by the WLAN. While only a single representative access point is shown in the figure, a conventional WLAN typically includes a plurality of access points.

The access point 14 is coupled to a central control unit (CCU) 18. The central control unit 18, amongst other things, provides control functions to various aspects of the operation of the WLAN. The central control unit, in turn, is connected to an external communication network, here a packet data network (PDN) 22. Other communication devices, not separately shown in the figure, are connected, directly or indirectly, to the packet data network. End-to-end communication services are effectuable between such communication devices and mobile stations operable in the WLAN by way of the appropriate access point 14 and upon radio channels defined upon a radio link formed between the mobile station and the access point. Two-way communication services, for instance, are effectuated with the mobile station in which packet-formatted data is communicated to the mobile station by way of forward-link channels defined upon the radio link. And, packet-formatted data originated at the mobile station is communicated by way of reverse-link channels defined upon the radio link.

Both the mobile station and the access point include radio transceiver circuitry for sending and receiving the packet-formatted data. Here, the radio transceiver circuitry embodied at the mobile station 12 is shown to include a receive part 28 and a transmit part 32. Data packets forming the packet-formatted data delivered to the mobile station are received by, and operated upon by, the receive part 28. Data packets originated at the mobile station are transmitted by the transmit part 32.

The communication system operates pursuant to a packet acknowledgment scheme in which the data packets delivered to a communication station, such as the mobile station 12, are acknowledged in a selected manner. The manner by which the delivery of the data packets is acknowledged is dependent upon the selected packet acknowledgment scheme pursuant to which the communication system is operable. Packet acknowledgment replies generated pursuant to the packet acknowledgment scheme are also communicated by the transmit part 32 to acknowledge the delivery of the data packets to the receive part 28.

The mobile station further includes apparatus 36 of an embodiment of the present invention. The apparatus 36 operates to facilitate the communications in the communication system by forming packet acknowledgment replies for acknowledging, pursuant to a selected packet acknowledgment scheme, delivery of the packet data to the mobile station. The apparatus 36 operates to form acknowledgment frames that are transmitted at transmission rates that are selectably transmitted at transmission rates that are higher than the minimum transmission rates used in the communication system. The apparatus is formed of functional entities implementable in any desired manner, such as, for example, by algorithms executable by processing circuitry.

In the exemplary implementation, the access point 14 includes analogous structure to acknowledge delivery of data packets thereto.

Here, the apparatus includes a packet detector 38 and a rate detector 42. The detectors 38 and 42 are coupled to the receive part 28 to receive indications of delivery of data packets to the receive part and results of operations performed on the data packets at the receive part. The rate detector 42 operates to detect the data transmission rate at which the data packets are communicated to the mobile station. As the communication system is a multi-rate communication system, the transmission rate at which a data packet is communicated to the mobile station is selectably of a selected data rate of more than one data rate. And the rate detector operates to detect the data rate. In one implementation, the data rate used by the mobile station pursuant to a communication session is identified during set-up procedures pursuant to the communication session. And, the rate detector, in one implementation, detects the data rate by obtaining information associated with the selected data rate identified during the communication set-up procedures.

The apparatus also includes a packet acknowledgment frame generator 44. The frame generator is coupled to the detector 38 and the detector 42, here by way of the lines 45, 46, and 48. The detector 38 generates acknowledgment values on the line 45 responsive to whether the data packets are successfully delivered at the receive part of the mobile station. An additional value is generated on the line 46 to identify the packet acknowledgment scheme pursuant to which the packet communication session is operable, viz., positive acknowledgment, negative acknowledgment, block acknowledgment, etc. And, the rate detector generates an indication on the line 48 to indicate the transmission rate at which the data packets are transmitted to and delivered to the mobile station.

The packet acknowledgment frame generator operates to generate a packet acknowledgment frame to acknowledge, pursuant to the appropriate packet acknowledgment scheme, the success of delivery of the data packet to the mobile station. The packet acknowledgment frame is generated for transmission at a transmission rate responsive to the transmission rate detected by the rate detector. In one implementation, the transmission rate at which the packet acknowledgment frame is transmitted corresponds to the data rate at which the data rate is transmitted to the mobile station. In another implementation, the transmission rate of the packet acknowledgment frame corresponds to the data rate at which the data packet is transmitted to the mobile station up to a selected maximum data rate, and the data rate of the packet acknowledgment frame does not exceed the maximum threshold.

The packet acknowledgment frame generated by the generator is here applied to the transmit part 32 to be caused to be transmitted therefrom.

While not separately shown, structure corresponding to that of the apparatus 36 is implemented at the access point 36. When two-way communication services are effectuated, analogous packet acknowledgments are returned by the access point, or communication endpoint, to the mobile station pursuant to the appropriate packet acknowledgment scheme.

In one implementation, the WLAN is operable pursuant to an IEEE 802.11(b) operating specification. When the communication system is operable pursuant to this variant of the IEEE 802.11 specification, the packet acknowledgment frame is transmitted at a rate that corresponds to the transmission rate at which the data packets are transmitted to the mobile station. In one implementation, a short pre-amp is further utilized for the packet acknowledgment frame if a corresponding short pre-amp is used to operate upon the data packets that are sent to the mobile station.

In another implementation, the communication system operates pursuant to the IEEE 802.11(a) operating specification. When the communication system is operable pursuant to this variant of the IEEE 802.11 operating specification, the data transmission rate of the packet acknowledgment frames correspond to that of the data rate at which the data packets are delivered to the mobile station up to a maximum amount. Symbol durations of 4 μs are used in the IEEE 802.11(a)-compliant system. The minimum transmission time of an acknowledgment payload is therefore 4 μs. And, more particularly, the size of the acknowledgment payload defined in the operating specification is 112 bits of MAC data frame and 22 bits of PLCP headers. The total size of the acknowledgment payload is, as a result, 134 bits. Through optimization of the amount of data bits per OFDM symbol, a preferred solution for the acknowledgment transmission is to use a 36 Mbit/s transmission mode rate. This transmission rate is preferred as the rate offers the smallest number of bits, 144 bits/symbol, where one acknowledgment fits in one symbol. While higher transmission rates can be utilized, the increased transmission rate fails to provide additional substantive advantages.

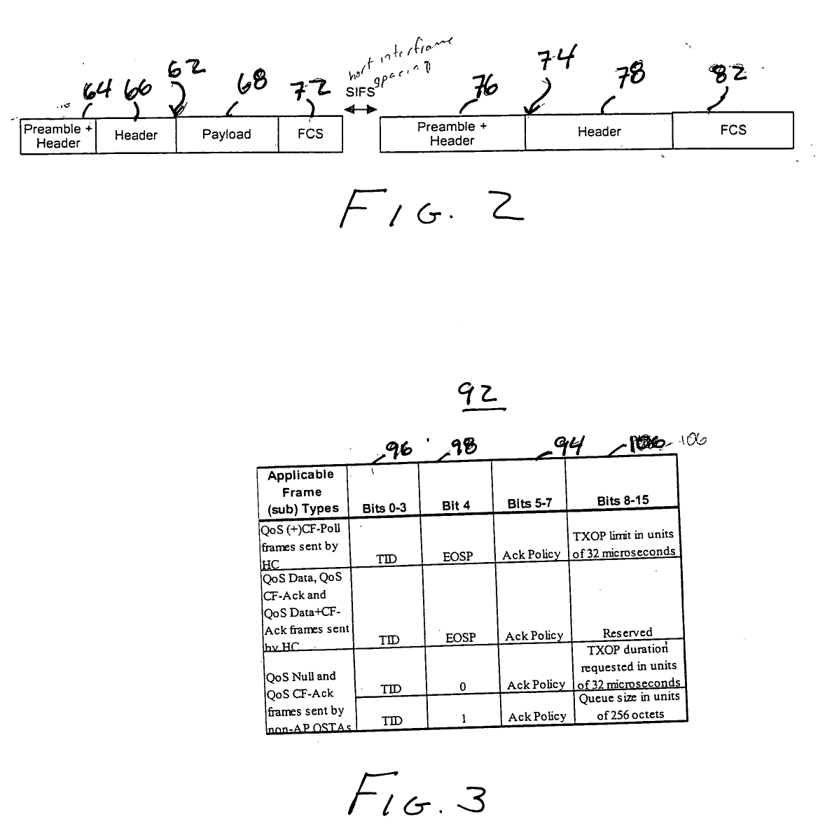

FIG. 2 illustrates the format of a related pair of data packet and acknowledgment indication. Here, the data packet, shown at 62, includes a preamble and header portion 64, a header portion 66, a payload portion 68, and an FCS portion 72. And, subsequent to a short interframe spacing interval (SIFS), a subsequent frame 74 includes a preamble and header part 76, a header portion 78, and an FCS portion 82.

In another implementation, the communication system is operable pursuant to an IEEE 802.11(e) operating specification. In this variant of the IEEE 802.11 standard, a QoS control field is defined. FIG. 3 illustrates a table, shown generally at 92, representative of a QoS control field that includes an acknowledgment policy field 94 pursuant to an embodiment of the present invention. Each of the four rows of the table identifies applicable frame subtypes and corresponding values in the fields 96 of bit numbers 0-3, field 98 of bit 4, the acknowledgment policy field 94, and the field 106 formed of bits 8-15. The acknowledgment policy field 94 of an embodiment of the present invention is of a length of three bits. Additional acknowledgment mode combinations are available through the use of a three bit acknowledgment policy field.

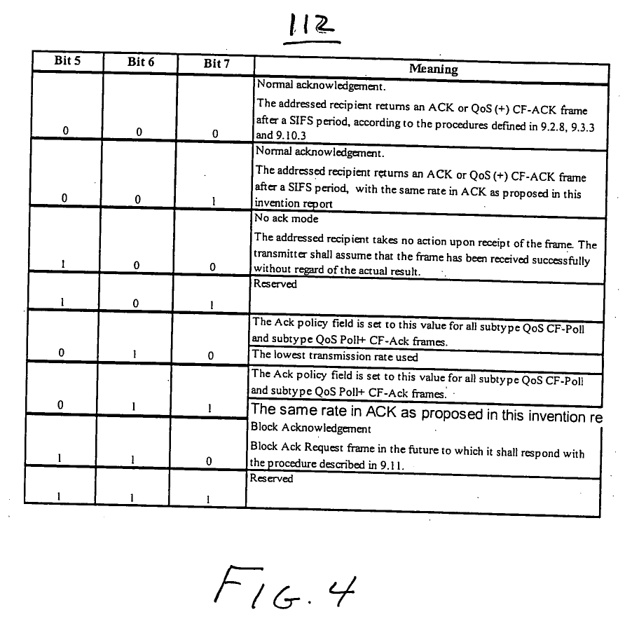

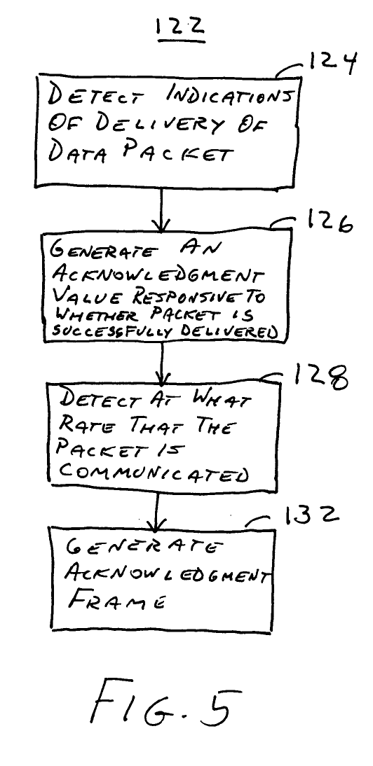

FIG. 4 illustrates a table 112 that identifies, for each of the possible values of the acknowledgment policy field, exemplary meanings associated with the values. The associations between the meanings and the values are, of course, exemplary, and other combinations and arrangements are alternately possible.

FIG. 5 illustrates a method flow diagram, shown generally at 122, representative of the method of operation of an embodiment of the present invention. The method facilitates feedback acknowledgment pursuant to a selected feedback acknowledgment scheme, selectably to acknowledge whether delivery of a data packet transmitted by a first communication station is delivered to a second communication station.

First, and as indicated by the block 124, indications of delivery of a data packet at the second communication station is detected.

Then, and as indicated by the block 126, an acknowledgment value is generated responsive to whether the data packet is successfully delivered to the second communication station. And, as indicated by the block 128, detection is made as to what data rate that the data packet is communicated by the first communication station to the second communication station.

Then, and as indicated by the block 132, an acknowledgment frame is generated. The acknowledgment frame is populated with an acknowledgment field value responsive to the acknowledgment value. The acknowledgment frame is for transmission back to the first communication station at a transmission rate responsive to the data rate.

Because the transmission rate at which the packet acknowledgment is communicated need not be at the minimum allowable transmission rate permitted in the communication system, improved communication efficiency and throughput is provided.

The previous descriptions are of preferred examples for implementing the invention, and the scope of the invention should not necessarily be limited by this description. The scope of the present invention is defined by the following claims.

What is claimed is:

1. Apparatus for a packet communication system having a set of communication stations formed of a first communication station and at least a second communication station, the first communication station at least for sending packet-formatted data to the second communication station to a selected feedback acknowledgment scheme, said apparatus for facilitating feedback acknowledgment by the second communication station pursuant to the selected acknowledgment feedback scheme, said apparatus comprising:
a packet detector adapted to receive indications of delivery of a data packet of the packet-formatted data at the second communication station said packet detector for generating an acknowledgment value responsive to whether the data packet is successfully delivered to the second communication station;
a rate detector adapted to receive indications of the delivery of the data packet of the packet-formatted data to the second communication station, said rate detector for detecting at what data rate that the data packet is communicated by the first communication station to the second communication station; and
an acknowledgment frame generator adapted to receive indications of the acknowledgment value generated by said packet detector and adapted to receive indications of the data rate detected by said rate detector, said acknowledgment frame generator for generating an acknowledgment frame populated with an acknowledgment field value responsive to the acknowledgment value, the acknowledgment frame for transmission back to the first communication station at a transmission rate responsive to the data rate.

2. The apparatus of claim 1 wherein the data packet of the packet-formatted data sent by the first communication station is selectably sent at a first transmission rate or at least at a second transmission rate, said rate detector for detecting at which of the first and at least second transmission rates at which the data packet of the packet-formatted data is sent by the first communication station.

3. The apparatus of claim 2 wherein the acknowledgment frame formed by said acknowledgment frame generator is transmitted to the first communication station at the first transmission rate when the data packet is sent at the first transmission rate and wherein the acknowledgment frame generator formed by said acknowledgment frame generator is transmitted to the first communication station at the second transmission rate when the data packet is sent at the second transmission rate.

4. The apparatus of claim 3 wherein the packet communication system is operable pursuant to an IEEE 802.11(b) operating specification and wherein the data packet, indications of the delivery of which are received by said packet detector are formatted in conformity with, and sent at a transmission rate permitted by, the IEEE 802.11(b) operating specification.

5. The apparatus of claim 1 wherein the acknowledgment frame formed by said acknowledgment frame generator is transmitted to the first communication station at the data rate detected by said data rate detector when the data rate is no greater than a selected maximum rate and, otherwise, at the selected maximum rate.

6. The apparatus of claim 5 wherein the acknowledgment frame is populated with at least a first symbol, the first symbol exhibiting a symbol length and wherein the selected maximum rate is dependent upon the symbol length.

7. The apparatus of claim 6 wherein the packet communication system is operable pursuant to a selected operating specification that defines the symbol length of symbols communicated during operation of the packet communication system and wherein the selected maximum rate is defined as a result of the symbol length defined by the operating specification.

8. The apparatus of claim 7 wherein the operating specification pursuant to which the packet communication system is operable comprises an IEEE 802.11(a) operating specification and wherein the data packet, indications of the delivery of which are received by said packet detector are formatted in conformity with the IEEE 802.11(a) operating specification.

9. The apparatus of claim 1 wherein the data packet of the packet-formatted data of which said packet detector is adapted to receive the indications thereof includes a quality of service field, the quality of service field further comprising an acknowledgment field, said packet detector further for detecting values populating the acknowledgment field and for generating an acknowledgment-mode value responsive thereto.

10. The apparatus of claim 9 wherein the acknowledgment field is of a three-bit length and wherein said packet detector detects values of each bit of the three-bit length field.

11. The apparatus of claim 9 wherein said acknowledgment frame generator is further adapted to receive indications of the acknowledgment mode value and wherein the acknowledgment frame generated thereat forms an acknowledgment type defined by the acknowledgment mode value.

12. The apparatus of claim 11 wherein the acknowledgment frame generated by said acknowledgment frame generator is generated pursuant to a positive acknowledgment scheme.

13. The apparatus of claim 11 wherein the acknowledgment frame generated by said acknowledgment frame generator is generated pursuant to a negative acknowledgment scheme.

14. The apparatus of claim 11 wherein the acknowledgment frame generated by said acknowledgment frame generator is generated pursuant to a block acknowledgment scheme.

15. The apparatus of claim 9 wherein the packet communication system is operable pursuant to an IEEE 802.11(c) operating specification and wherein the data packet, indications of delivery of which are received by said packet detector are formatted in conformity with, and sent at a transmission rate, permitted by the IEEE 802.11(e) operating specification.

16. The apparatus of claim 1 wherein the packet communication system comprises a wireless local area network, wherein the second communication station comprises a mobile node and wherein said packet detector, said rate detector, and said acknowledgment frame generator are embodied at the mobile node.

17. A method for communicating in a packet communication system having a set of communication stations formed of a first communication station and at least a second communication station, the first communication station at least for sending packet-formatted data to the second communication station to a selected feedback acknowledgment scheme, said method for facilitating feedback acknowledgment by the second communication station pursuant to the selected acknowledgment feedback scheme, said method comprising the operations of:
detecting indications of delivery of a data packet of the packet-formatted data at the second communication station;
generating an acknowledgment value responsive to whether the data packet is successfully delivered to the second communication station;
detecting at what data rate that the data packet is communicated by the first communication station to the second communication station;
generating an acknowledgment frame populated with an acknowledgment field value responsive to the acknowledgment value, the acknowledgment frame for transmission back to the communication station at a transmission rate responsive to the data rate.

18. The method of claim 17 wherein the data packet of the packet-formatted data sent by the first communication station is selectably sent at a first transmission rate or at least at a second transmission rate, said operation of detecting for detecting at which of the first and at least second transmission rates that the data packet of the packet-formatted data is sent.

19. The method of claim 18 wherein the acknowledgment frame generated during said operation of generating the acknowledgment frame is transmitted to the first communication station at the first transmission rate when the data packet is sent at the first transmission rate and wherein the acknowledgment frame generated during said operation of generating the acknowledgment frame is transmitted to the first communication station at the second transmission rate when the data packet is sent at the second transmission rate.

20. The method of claim 17 wherein the acknowledgment frame generated during said operation of generating the acknowledgment frame is transmitted to the first communication station at the data rate detected during said operation of detecting when the data rate is no greater than a selected maximum rate and, otherwise, at the selected maximum rate.
